(19) United States
(12) Patent Application Publication
(10) Pub. No.: US 2012/0133286 A1
(43) Pub. Date: May 31, 2012

(54) LIGHTING APPARATUS

(76) Inventor: Hiroto Uhara, Osaka-shi (JP)

(21) Appl. No.: 13/389,203

(22) PCT Filed: Jun. 15, 2010
(86) PCT No.: PCT/JP2010/060109

§ 371 Date: Feb. 6, 2012

(30) Foreign Application Priority Data
Aug. 7, 2009 (JP) 2009-185169

(51) Int. Cl. H05B 37/02

(52) U.S. Cl. 315/122; 315/151

(57) ABSTRACT

Provided is a lighting apparatus which supplies current from direct-current power supplies to light-emitting diodes, detects current flowing through the light-emitting diodes, and performs on/off control of the direct-current power supplies. The lighting apparatus includes a resistance connected between the direct-current power supplies and a fixed potential terminal, a voltage dividing circuit for dividing a predetermined voltage, a PWM control circuit and FET for variably controlling a dividing ratio of the voltage dividing circuit by PWM control based on a duty ratio in accordance with an operation for setting brightness, and a comparison circuit for comparing a voltage associated with a both-end voltage of the resistance with an output voltage of the voltage dividing circuit. The lighting apparatus performs on/off control of the direct-current power supplies in accordance with the comparison result obtained by the comparison circuit.

This application is the national phase under 35 U.S.C. §371 of PCT International Application No. PCT/JP2010/060109 which has an International filing date of Jun. 15,2010 and designated the United States of America.

### BACKGROUND

1. Technical Field

The present invention relates to a lighting apparatus performing dimmer control by changing a current value supplied to an LED (light-emitting diode), and more specifically to a method of controlling the current value.

2. Description of Related Art

The LED has a high luminous efficiency, can be used with a low voltage and is effective in energy saving. Ever since a white LED was developed, the LED has been used as a light source (backlight) of a liquid-crystal display apparatus, and has recently been used in a lighting apparatus in general. When used for these purposes, it is common to arrange a number of LEDs in array alignment and connect them in series with each other through which the same current flows, since a single LED has a small power output. This prevents the occurrence of unevenness in light emission.

Japanese Patent Application Laid-Open No. 2008-192730 discloses an LED driving circuit provided with: an LED serial circuit in which a number of LEDs are connected in series; a register group including the first switching device connected in series with the LED serial circuit to control the conducting current thereof, plural registers connected in parallel that are connected between the first switching device and a ground terminal, and the second switching device connected in series with the registers; and a setting circuit for setting on and off of the second switching device.

### SUMMARY

In the conventional lighting apparatus using LED of a system in which a current value is altered by changing a resistance value, there has been a problem in that waste of energy, i.e. heat generation, occurs due to a resistance.

Moreover, the levels of dimmer control are determined by the number of mounted resistances, hindering free control of light.

Furthermore, unevenness in brightness (illuminance, luminance) cannot be corrected.

The present invention has been made in view of the circumstances described above. An object of the invention is to provide a lighting apparatus using LED which can freely perform dimmer control by changing a current value supplied to an LED and in which waste of energy (heat generation) due to a resistance is less.

Another object of the present invention is to provide a lighting apparatus using LED that can correct unevenness in brightness (illuminance, luminance).

A further object of the present invention is to provide a lighting apparatus using LED which can perform dimmer control by changing a current value supplied to an LED and in which waste of energy (heat generation) due to a resistance is less.

A lighting apparatus according to the present invention that supplies current from a direct-current power supply to one or more light-emitting diodes, detects current flowing in the light-emitting diode and performs on/off control of the direct-current power supply based on the detected current to control the current flowing in the light-emitting diode is characterized by including: a resistance connected between the direct-current power supply and a fixed potential terminal; a voltage dividing circuit for dividing a predetermined voltage; a PWM (Pulse Width Modulation) control circuit variably controlling a dividing ratio of the voltage dividing circuit by PWM control based on a duty ratio in accordance with an operation from an outside for setting brightness; and a comparison circuit for comparing a voltage associated with a both-end voltage of the resistance with an output voltage of the voltage dividing circuit. The lighting apparatus performs on/off control for the direct-current power supply in accordance with a comparison result obtained by the comparison circuit.

In the lighting apparatus, current is supplied from the direct-current power supply to one or more light-emitting diodes, the current flowing in the light-emitting diode is detected, and the current flowing in the light-emitting diode is controlled by performing on/off control for the direct-current power supply based on the detected current. The voltage dividing circuit divides a predetermined voltage, while the PWM control circuit performs PWM control based on a duty ratio in accordance with the operation from the outside for setting brightness, to variably control a dividing ratio of the voltage dividing circuit. The comparison circuit compares the voltage associated with the both-end voltage of the resistance connected between the direct-current power supply and the fixed potential terminal with the output voltage of the voltage dividing circuit, to perform on/off control for the direct-current power supply in accordance with the comparison result of the comparison circuit.

In the lighting apparatus according to the present invention, the PWM control circuit includes a serial circuit connected in parallel with one of a plurality of voltage-dividing resistances of the voltage dividing circuit and having a current-limiting resistance and a field effect transistor connected in series, and the PWM control circuit applies a PWM signal to a gate of the field effect transistor.

In the lighting apparatus, the PWM control circuit is configured to have the serial circuit in which the current-limiting resistance and field effect transistor are connected in series and which is connected in parallel with one of the plurality of voltage-dividing resistances of the voltage dividing circuit, to apply a PWM signal to the gate of the field effect transistor.

The lighting apparatus according to the present invention further includes: a sensor for detecting brightness of the light-emitting diode; a means for comparing the brightness detected by the sensor with the brightness set by the operation; and a means for increasing or decreasing the duty ratio in accordance with a result of comparison made by the means for comparing. The brightness of the light-emitting diode is made to correspond to the brightness set by the operation described above.

In the lighting apparatus, the sensor detects the brightness of the light-emitting diode, while the means for comparing compares the brightness detected by the sensor with the brightness set by the operation. The means for increasing/decreasing increases or decreases the duty ratio of PWM control in accordance with the comparison result to correspond the brightness of the light-emitting diode to the brightness set by the operation.

A lighting apparatus according to the present invention that supplies current from a direct-current power supply to one or more light-emitting diodes, detects current flowing in the light-emitting diode and performs on/off control of the direct-current power supply based on the detected current to control the current flowing in the light-emitting diode is characterized by including: a current-detecting resistance connected between the direct-current power supply and a fixed potential terminal; a voltage dividing circuit having a plurality of resistances connected in series and one or more switches for bypassing the resistances, to divide a predetermined voltage; a means for changing a dividing ratio of the voltage dividing circuit by turning on or off the switch in response to an operation from an outside; and a comparison circuit for comparing a voltage associated with a both-end voltage of the current-detecting resistance with an output voltage of the voltage dividing circuit. The lighting apparatus performs on/off control for the direct-current power supply in accordance with a comparison result obtained by the comparison circuit.

In the lighting apparatus, current is supplied from the direct-current power supply to one or more light-emitting diode, the current flowing in the light-emitting diode is detected, and the current flowing in the light-emitting diode is controlled by performing on/off control for the direct-current power supply based on the detected current. The current-detecting resistance is connected between the direct-current power supply and the fixed potential terminal, while the voltage-dividing circuit has a plurality of resistances connected in series and one or more switches bypassing the resistances to divide the predetermined voltage. The means for changing turns on or off the switch in accordance with the operation from the outside, so that the voltage-dividing ratio of the voltage-dividing circuit is changed, the comparison circuit compares the voltage associated with the both-end voltage for the current-detecting resistance with the output voltage of the voltage-dividing circuit, to perform on/off control for the direct-current power supply in accordance with the comparison result of the comparison circuit.

The present invention can realize a lighting apparatus using LED that can perform dimmer control by changing current flowing through the LED with a simple configuration.

The present invention can realize a lighting apparatus using LED that can correct unevenness in brightness (illuminance, luminance) with a simple configuration.

The lighting apparatus according to the present invention performs dimmer control by changing the current value supplied to an LED, the supplied current value being controlled by a comparison circuit whose reference potential can be freely altered by performing PWM control on the FET connected thereto. Thus, stepless (levelless) dimmer control can be implemented. Moreover, an illuminance sensor is used to feed back the brightness, so that a prescribed brightness can easily be obtained.

The above and further objects and features will more fully be apparent from the following detailed description with accompanying drawings.

### BRIEF DESCRIPTION OF THE SEVERAL VIEWS OF THE DRAWINGS

FIG. 1 is a block diagram illustrating a configuration of a main part of an embodiment of the lighting apparatus according to the present invention;

FIG. 2 is a flowchart illustrating an operation of an embodiment of the lighting apparatus according to the present invention;

FIG. 3 is a flowchart illustrating an operation of an embodiment of the lighting apparatus according to the present invention;

FIG. 4 is an explanatory view illustrating an example of association between dimmer levels to be set and an on duty ratio for PWM controlling a field effect transistor FET;

FIG. 5 is an explanatory view illustrating an example of association between the illuminance at one meter below an LED, the output voltage of the illuminance sensor and the AD conversion value; and

FIG. 6 is a block diagram illustrating a configuration of a main part of an embodiment of the lighting apparatus according to the present invention.

### DETAILED DESCRIPTION

The present invention will be described below with reference to drawings illustrating the embodiments thereof.

### Embodiment 1

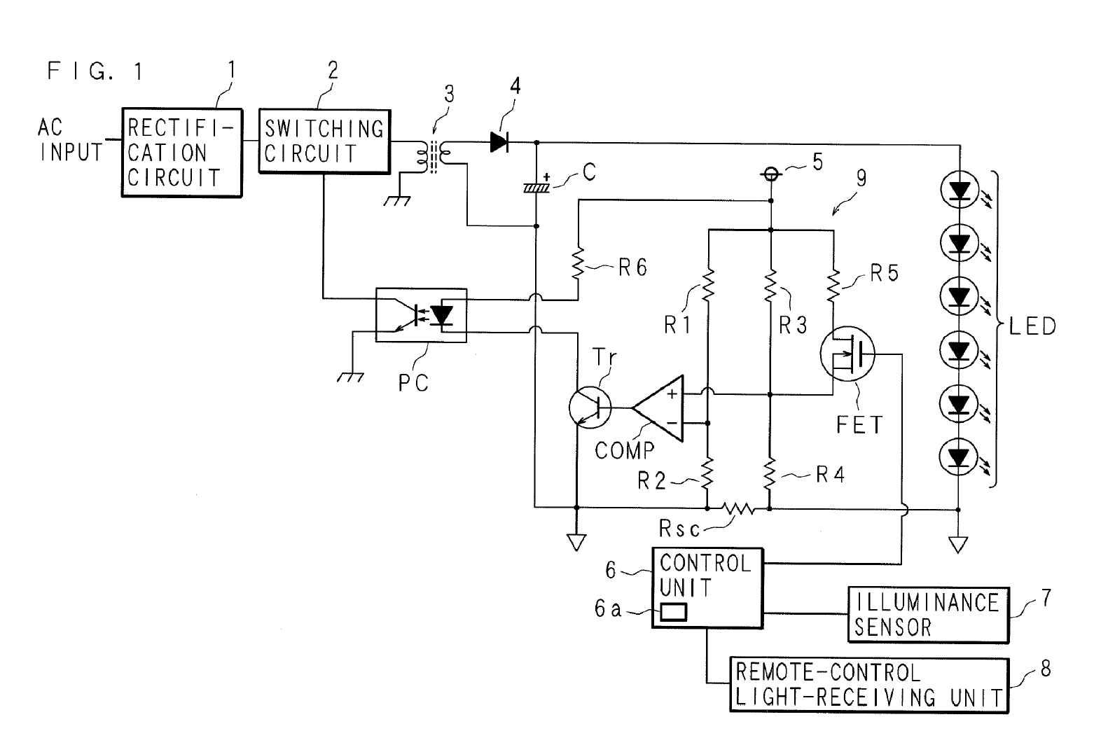

FIG. 1 is a block diagram illustrating a configuration of a main part of Embodiment 1 of the lighting apparatus according to the present invention. The lighting apparatus is provided with a rectification circuit 1 for rectifying alternating-current power (AC input), a switching circuit 2 for switching the direct-current power rectified by the rectification circuit 1, a transformer 3 for lowering the voltage of the power switched by the switching circuit 2, and a diode 4 for rectifying the secondary current of the transformer 3.

The lighting apparatus includes a smoothing capacitor C for smoothing the direct current rectified by the diode 4 and six light-emitting diodes LED connected in series, to which the direct current rectified by the diode 4 and smoothed by the smoothing capacitor C is supplied, the cathode of the sixth LED being connected to the ground terminal (fixed potential terminal).

The lighting apparatus also includes an illuminance sensor (sensor) 7 provided near the six LEDs, a remote-control light-receiving unit 8 receiving the operation signal light from a remote control device and a control unit 6 connected to each of the illuminance sensor 7 and remote-control light-receiving unit 8. It is also possible to use a brightness sensor in place of the illuminance sensor 7 to perform control described below on the basis of brightness.

The lighting apparatus further includes a voltage dividing circuit 9, in which a serial circuit with resistances R1, R2 and a serial circuit with resistances R3, R4 are connected in parallel with each other and a serial circuit with a resistance R5 and an N-channel field effect transistor FET is connected in parallel with the resistance R3, to divide a constant voltage (predetermined voltage) of a control power supply 5 into voltages for each of the above. A current detecting resistance Rsc is inserted between the resistances R2 and R4 on the ground line. The connection node of the resistance R2 and current detecting resistance Rsc is connected to the secondary low-voltage terminal of transformer 3 and to the cathode terminal of smoothing capacitor C through the ground line.

The gate of the field effect transistor FET is PWM controlled by the control unit 6.

The lighting apparatus further includes a comparator COMP with its negative input terminal connected to the connection node of the resistances R1 and R2, and its positive input terminal connected to the connection node of the resistances R3 and R4, and also includes an NPN transistor Tr with its base connected to the output terminal of the comparator COMP. The emitter of the transistor Tr is grounded.

The lighting apparatus further includes a photo coupler PC, in which the anode of a light-emitting diode on the primary side is connected to the control power supply 5 through a resistance R6 while the cathode thereof is connected to the collector of the transistor Tr, and the emitter of the phototransistor on the secondary side is grounded while the collector thereof is connected to the switching circuit 2.

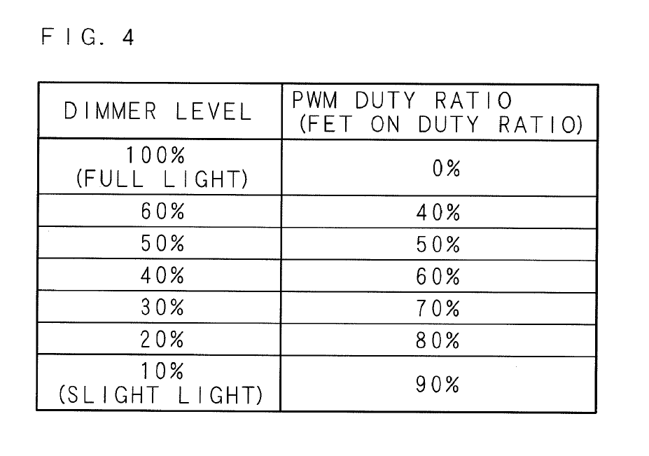

The lighting apparatus can continuously perform dimmer control. The control unit 6 includes, as partially illustrated in FIG. 4, a table in a built-in memory 6a, the table showing the association between dimmer levels (illuminance) set by receiving instructions from the remote-control light-receiving unit 8 in response to user's operation and on duty ratios for PWM controlling the field effect transistor FET.

The control unit 6 PWM controls the field effect transistor FET with the on duty ratios of 0%, 40%, 50%, 60%, 70%, 80% and 90%, when the dimmer levels set by receiving the instructions from the remote-control light-receiving unit 8 are, for example, 100%, 60%, 50%, 40%, 30%, 20% and 10%, respectively.

The resistances R1 to R6 and the current-detecting resistance Rsc of the voltage dividing circuit 9 are so set that the voltage divided by the resistances R1, R2 and current-detecting resistance Rsc at each of the dimmer levels matches with the voltage divided by the resistances R3 to R5 when the field effect transistor FET is PWM controlled at a duty ratio in accordance with the same dimmer level.

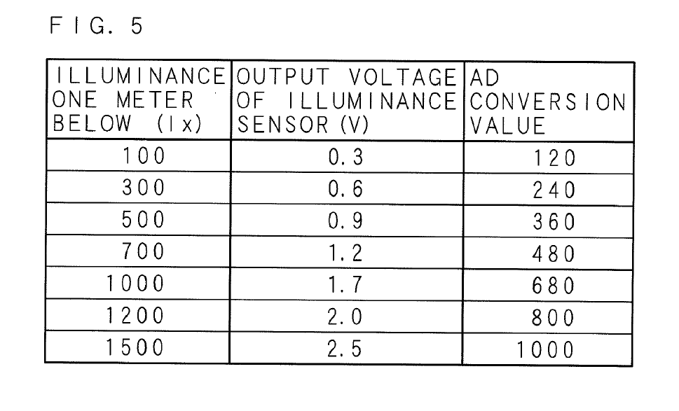

The illuminance sensor 7 is provided near the light-emitting diodes LED, and outputs, as partially illustrated in FIG. 5, 0.3V, 0.6V, 0.9V, 1.2V, 1.7V, 2.0V and 2.5V, at the illuminance obtained by distance conversion from the illuminance of 100 lx, 300 lx, 500 lx, 700 lx, 1000 lx, 1200 lx and 1500 lx, respectively, each of which is obtained at one meter directly below the light-emitting diode LED.

Analog-to-digital conversion is performed at the control unit 6 on the voltages outputted by the illuminance sensor 7, to obtain AD conversion values as illustrated in FIG. 5 for example, with the maximum value being 1000.

As partially illustrated in FIG. 5, the control unit 6 includes a table in the memory 6a showing the association between illuminance one meter directly below the light-emitting diode LED corresponding to the dimmer levels to be set and AD conversion values (480 at 700 lx, for example). The control unit 6 compares the AD conversion value read out with reference to the table and the AD conversion value for the voltage outputted by the illuminance sensor 7, and controls, i.e. increases or decreases, the duty ratio for PWM controlling the field effect transistor FET according to the comparison result.

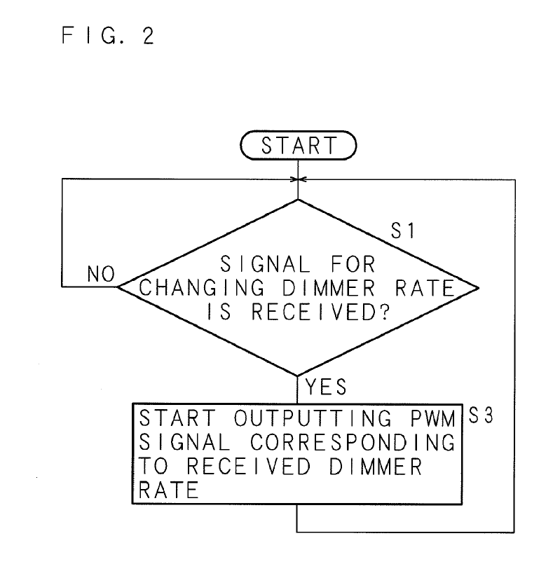

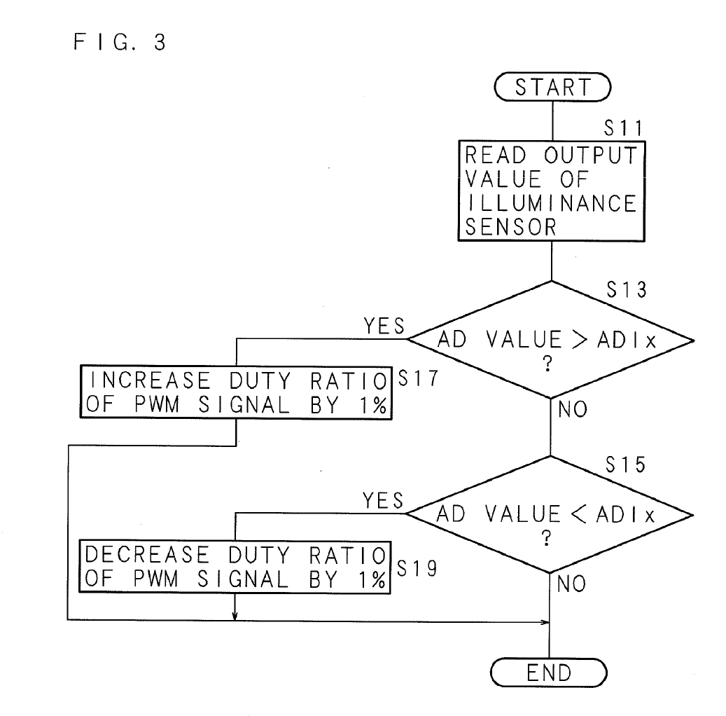

The operation of the lighting apparatus configured as above will now be described below with reference to the flowcharts in FIGS. 2 and 3 illustrating thereof.

When receiving an operation signal for changing a dimmer rate (illuminance) by the remote-control light-receiving unit 8 (S1 in FIG. 2), the control unit 6 starts outputting a PWM signal at a duty ratio corresponding to the received dimmer rate (S3) and PWM controls the field effect transistor FET. Accordingly, when the voltage divided by the resistances R3 to R5 is higher than the voltage divided by the resistances R1, R2 and current-detecting resistance Rsc (when the current flowing in the current-detecting resistance Rsc is smaller), the comparator COMP turns on the switching circuit 2 through the transistor Tr and photo coupler PC, whereas it turns off the switching circuit 2 otherwise. This allows both voltages match with each other, making the current corresponding to the duty ratio flow through the current-detecting resistance Rsc and light-emitting diodes LED.

The control unit 6 reads the voltage outputted by the illuminance sensor 7 periodically (every ten seconds, for example) (S11 in FIG. 3), converts it into an AD (conversion) value, and determines whether or not the converted value is larger than the AD (conversion) value ADlx (e.g. 480) corresponding to the set illuminance (e.g. 700 lx) read from the table (S1 in FIG. 2) (S13). When the converted AD (conversion) value is larger than the AD (conversion) value ADlx, the control unit 6 increases the duty ratio for PWM controlling the field effect transistor FET by one percent (S17), and terminates the processing.

When the converted AD (conversion) value is not larger than the AD (conversion) value ADlx (S13), the control unit 6 determines whether or not the converted AD (conversion) value is smaller than the AD (conversion) value ADlx (S15). When the converted AD (conversion) value is smaller than the AD (conversion) value ADlx, the control unit 6 decreases the duty ratio for PWM controlling the field effect transistor FET by one percent (S19), and terminates the processing.

The control unit 6 repeats the operations as described above (S11 to S19) every ten seconds, to obtain the set illuminance (S1 in FIG. 2) (700 lx for example) for the last time.

### Embodiment 2

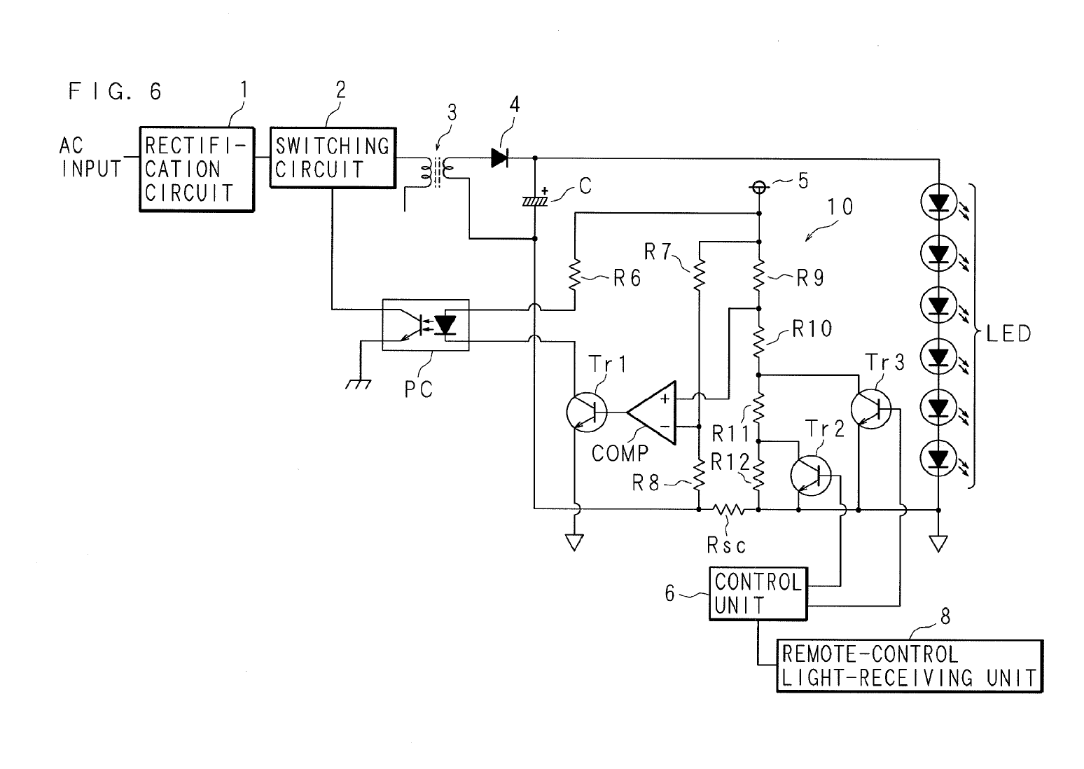

FIG. 6 is a block diagram illustrating a configuration of a main part of a lighting apparatus according to Embodiment 2 of the present invention. The lighting apparatus includes a remote-control light-receiving unit 8 for receiving operation signal light from a remote control device (not shown) and a control unit 6 connected to the remote-control light-receiving unit 8. Furthermore, the lighting apparatus includes a voltage dividing circuit 10, in which a serial circuit with resistances R7, R8 is connected in parallel with a serial circuit with resistances R9, R10, R11, R12 and which has an NPN transistor Tr3 for bypassing the resistances R11, R12 as well as an NPN transistor Tr2 for bypassing the resistance R12, to divide a constant voltage (predetermined voltage) of a control power supply 5 for each of the above.

A current-detecting resistance Rsc is inserted between the resistances R8 and R12 on the ground line, while the connection node of the resistance R8 and current-detecting resistance Rsc is connected to the secondary lower-voltage terminal of a transformer 3 and the cathode terminal of a smoothing capacitor through the ground line.

Each base of the transistors Tr2, Tr3 is connected to the control unit 6, which turns on or off the transistors Tr2 and Tr3.

The lighting apparatus further includes: a comparator COMP with its negative input terminal connected to the connection node of resistances R7 and R8, and its positive input terminal connected to the connection node of resistances R9 and R10; and an NPN transistor Tr1 having a base connected to the output terminal of the comparator COMP. The emitter of transistor Tr1 is grounded.

The lighting apparatus further includes a photo coupler PC, in which the anode of a light-emitting diode on the primary side is connected to the control power supply 5 through the resistance R6 while the cathode thereof is connected to the collector of transistor Tr1, and the emitter of the phototransistor on the secondary side is grounded while the collector thereof is connected to the switching circuit 2.

The voltage dividing circuit 10 can supply output voltages of three levels in the case where the transistors Tr2, Tr3 are (off, off), (on, off), (off (on), on) to the positive input terminal of comparator COMP, so that the dimmer levels can be set as three levels.

The resistances R7 to R12 and current-detecting resistance Rsc of the voltage dividing circuit 10 are so set that the voltage divided by the resistances R7, R8 and current-detecting resistance Rsc at each of the dimmer levels matches with the voltage divided by the resistances R9 to R12 in the on/off state of the transistors Tr2, Tr3 in accordance with each of the dimmer levels. The other configuration parts are similar to those of the lighting apparatus described in Embodiment 1 (FIG. 1), and will not be described here.

In the lighting apparatus with such a configuration, when receiving an operation signal for changing a dimmer rate (illuminance) by the remote-control light-receiving unit 8, the control unit 6 turns on or off the transistors Tr2, Tr3, in association with the received dimmer rate (illuminance). Accordingly, when the voltage divided by the resistances R9 to R12 is higher than the voltage divided by the resistances R7, R8 and current-detecting resistance Rsc (when the current flowing in the current-detecting resistance Rsc is smaller), the comparator COMP turns on the switching circuit 2 through the transistor Tr1 and photo coupler PC, whereas it turns off the switching circuit 2 otherwise. Thus, the both voltages match with each other, making the current corresponding to the dimmer rate (illuminance) flow through the current-detecting resistance Rsc and light-emitting diodes LED.

The present invention may be applicable to a lighting apparatus which performs dimmer control by changing the current value supplied to a light-emitting diode, and more specifically to a lighting apparatus controlling the current value.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1.-4. (canceled)

5. A lighting apparatus supplying current from a direct-current power supply to one or more light-emitting diodes, detecting current flowing in the light-emitting diode and performing on/off control of the direct-current power supply based on the detected current to control the current flowing in the light-emitting diode, comprising:
a resistance connected between the direct-current power supply and a fixed potential terminal;
a voltage dividing circuit for dividing a predetermined voltage;
a PWM control circuit variably controlling a dividing ratio of the voltage dividing circuit by PWM control based on a duty ratio in accordance with an operation from an outside for setting brightness; and
a comparison circuit for comparing a voltage associated with a both-end voltage of the resistance with an output voltage of the voltage dividing circuit,
wherein the lighting apparatus performs on/off control for the direct-current power supply in accordance with a comparison result obtained by the comparison circuit.

6. The lighting apparatus according to claim 5, wherein
the PWM control circuit includes a serial circuit connected in parallel with one of a plurality of voltage-dividing resistances of the voltage dividing circuit and having a current-limiting resistance and a field effect transistor connected in series, and
the PWM control circuit applies a PWM signal to a gate of the field effect transistor.

7. The lighting apparatus according to claim 5, further comprising:
a reception unit for receiving an operation signal for changing a dimmer rate from an outside; and
a memory including a table showing an association between a dimmer level set by the operation signal received by the reception unit and a duty ratio of the PWM control,
wherein the PWM control circuit is configured to continuously perform dimmer control based on the operation signal.

8. The lighting apparatus according to claim 5, further comprising:
a sensor for detecting brightness of the light-emitting diode;
a comparison unit for comparing the brightness detected by the sensor with the brightness set by said operation; and
a increasing/decreasing unit for increasing or decreasing the duty ratio in accordance with a result of comparison made by the comparison unit,
wherein the brightness of the light-emitting diode is made to correspond to the brightness set by said operation.

9. The lighting apparatus according to claim 8, wherein an operation for corresponding the brightness of the light-emitting diode to the brightness set by said operation is periodically repeated.

10. A lighting apparatus supplying current from a direct-current power supply to one or more light-emitting diodes, detecting current flowing in the light-emitting diode and performing on/off control of the direct-current power supply based on the detected current to control the current flowing in the light-emitting diode, comprising:
a current-detecting resistance connected between the direct-current power supply and a fixed potential terminal;
a voltage dividing circuit having a plurality of resistances connected in series and one or more switches for bypassing the resistances, to divide a predetermined voltage;
a changing unit for changing a dividing ratio of the voltage dividing circuit by turning on or off the switch in response to an operation from an outside; and
a comparison circuit for comparing a voltage associated with a both-end voltage of the current-detecting resistance with an output voltage of the voltage dividing circuit,
wherein the lighting apparatus performs on/off control for the direct-current power supply in accordance with a comparison result obtained by the comparison circuit.
